(19) United States
(12) Patent Application Publication
(10) Pub. No.: US 2010/0158243 A1
(43) Pub. Date: Jun. 24, 2010

(54) METHOD OF ENCRYPTION IN NETWORKED EMBEDDED SYSTEMS

(75) Inventors: Yuan Tian, Mountain View, CA (US); Abtin Keshavarzian, Palo Alto, CA (US)

Correspondence Address: TAFT STETTINIUS & HOLLISTER LLP, ONE INDIANA SQUARE, SUITE 3500, INDIANAPOLIS, IN, 46204, US

(73) Assignee: Robert Bosch GmbH, Stuttgart (DE)

(21) Appl. No.: 12/339,537

(22) Filed: Dec. 19, 2008

(51) Int. Cl. H04K 1/00; H04K 1/04

(52) U.S. Cl. 380/37

(57) ABSTRACT

A data encryption method includes providing a sender node having information to transmit. The information is divided into a sequence of frames. A respective one of a plurality of frame numbers is assigned to each of the frames. At least one nonce and at least one security key are used to perform block cipher encryption and produce within the sender node a respective block cipher encryption output for each of the frames. The information is converted from a sequence of plaintext frames to a sequence of ciphertext frames by use of the block cipher encryption outputs produced within the sender node. The converting is performed within the sender node and after the block cipher encryption outputs have been produced within the sender node. A receiver node is used to ascertain the frame numbers. The at least one nonce is transmitted from the sender node to the receiver node. The at least one nonce and the at least one security key are used to perform block cipher encryption and produce within the receiver node a respective block cipher encryption output for each of the frames. The ciphertext frames are transmitted from the sender node to the receiver node. The ciphertext frames are transmitted after the block cipher encryption outputs have been produced within the receiver node. The transmitted ciphertext is converted back into the plaintext frames by use of the block cipher encryption outputs produced within the receiver node. The converting is performed within the receiver node and after the block cipher encryption outputs have been produced within the receiver node.

### COPYRIGHT NOTICE

Portions of this document are subject to copyright protection. The copyright owner does not object to facsimile reproduction of the patent document as it is made available by the U.S. Patent and Trademark Office. However, the copyright owner reserves all copyrights in the software described herein and shown in the drawings. The following notice applies to the software described and illustrated herein: Copyright © 2008, Robert Bosch GmbH, All Rights Reserved.

### BACKGROUND OF THE INVENTION

1. Field of the Invention

The present invention relates to a computer implemented method for cryptography, and, more particularly, to a computer implemented block cipher encryption method for use in networked embedded systems.

2. Description of the Related Art

Encryption is a method of protecting communicated data from unauthorized eavesdropping. The communicated data or message is referred to as “plaintext” before the encryption process and after the decryption process. After encryption, the message may be referred to as “ciphertext,” and it in this form that the message is transmitted over a communications channel or is stored within a computer memory storage device. Thus, the process of transforming the message from plaintext to ciphertext is known as “encryption.” Conversely, the process of transforming the message from ciphertext to plaintext is known as “decryption.” Both encryption and decryption are controlled by binary keys. Without access to the encryption key, a message cannot be encrypted, even with knowledge of the encryption process. Similarly, without access to the decryption key, the message cannot be decrypted, even with knowledge of the decryption process.

The data encryption process scrambles the plaintext message into ciphertext in order to prevent unauthorized access to the transmitted message. The decryption process extracts the plaintext message from the ciphertext encrypted data. Symmetric key encryption processes are those that utilize the same key in the encryption and decryption processes.

A block cipher is a type of encryption algorithm that transforms a block of plaintext into a block of ciphertext. When transformed through a block cipher, the plaintext and ciphertext have the same length. The secret key controls the transformation from the plaintext to the ciphertext. Decryption is the process of using the same secret key to apply a reverse transformation to the ciphertext block to restore the plaintext block.

Most known encryption/decryption security algorithms are computationally intensive, and are thus difficult to implement in a networked embedded system, which typically has limited computational capacity. An embedded system is a computer system that is designed with a special purpose or to perform a small number of dedicated functions. Such embedded systems often have real-time computing constraints, and may be embedded within a device that is complete with hardware and mechanical parts. Most known encryption/decryption methods are focused or optimized in terms of the security algorithms themselves, and do not address how to implement the algorithms in real systems that have limited computation power and strict response latency requirements.

Another problem with most known encryption/decryption security algorithms is that counter values are maintained at the packet level by individual nodes, which occupies a high level of processing time and other resources. Moreover, such counter values are not predictable in that a sequence of counter values that will be used by a node in the future cannot be predetermined.

What is neither disclosed nor suggested by the prior art is a method of ensuring data security and meeting low computation latency requirements by use of computationally intensive encryption algorithms in embedded systems that have low processing power.

### SUMMARY OF THE INVENTION

The present invention provides a method for implementing a computationally intensive encryption/decryption algorithm in a networked embedded system with low computational power which still satisfies low latency requirements. The invention implements an algorithm to enable data encryption/decryption upon transmission/reception with only a small computing delay.

The invention comprises, in one form thereof, a method of data encryption including providing a sender node having information to transmit. The information is divided into a sequence of frames. A respective one of a plurality of frame numbers is assigned to each of the frames. At least one nonce and at least one security key are used to perform block cipher encryption and produce within the sender node a respective block cipher encryption output for each of the frames. The information is converted from a sequence of plaintext frames to a sequence of ciphertext frames by use of the block cipher encryption outputs produced within the sender node. The converting is performed within the sender node and after the block cipher encryption outputs have been produced within the sender node. A receiver node is used to ascertain the frame numbers. The at least one nonce is transmitted from the sender node to the receiver node. The at least one nonce and the at least one security key are used to perform block cipher encryption and produce within the receiver node a respective block cipher encryption output for each of the frames. The ciphertext frames are transmitted from the sender node to the receiver node. The ciphertext frames are transmitted after the block cipher encryption outputs have been produced within the receiver node. The transmitted ciphertext is converted back into the plaintext frames by use of the block cipher encryption outputs produced within the receiver node. The converting is performed within the receiver node and after the block cipher encryption outputs have been produced within the receiver node.

The invention comprises, in another form thereof, a data encryption method including providing information that is divided into a sequence of frames. A respective one of a plurality of frame numbers is assigned to each of the frames. At least one nonce and at least one security key are used to perform block cipher encryption and produce a respective block cipher encryption output for each of the frames. The information from a sequence of plaintext frames or a sequence of ciphertext frames is converted to the other of the sequence of plaintext frames and the sequence of ciphertext frames. The converting is performed by use of the block cipher encryption outputs. The converting is initiated after the block cipher encryption outputs have been produced. The converting is initiated before any of the group of the block cipher encryption outputs have been used in a converting step.

The invention comprises, in yet another form thereof, a data encryption method including providing information that is divided into a sequence of frames. A respective one of a plurality of frame numbers is assigned to each of the frames. At least one nonce and at least one security key are used to perform block cipher encryption and produce a respective block cipher encryption output for each of the frames. A sequence of frames of pseudo text is provided. Each of the block cipher encryption outputs is converted into a respective binary random vector by use of the pseudo text. The information is converted from a sequence of plaintext frames or a sequence of ciphertext frames to the other of the sequence of plaintext frames and the sequence of ciphertext frames. The converting of the information is performed by use of the binary random vectors. The converting of the information is initiated after the converting of the block cipher encryption outputs into the binary random vectors. The converting of the information is initiated before any of the binary random vectors have been used in a converting step.

An advantage of the present invention is that it provides computationally intensive data encryption/decryption in networked embedded systems having low computational capacity.

Another advantage is that the encryption/decryption algorithm may be implemented while satisfying requirements for low computational latency.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a wireless system suitable for use with the method of the present invention.

FIG. 2 is a diagram illustrating the format of a frame in the time domain according to one embodiment of a method of the present invention.

FIG. 3 is a block diagram illustrating one embodiment of an encryption method of the present invention.

FIG. 4 is a block diagram illustrating one embodiment of a decryption method of the present invention.

FIG. 5 is a timing diagram illustrating the staggering of two stages of the algorithm of the present invention across a sequence of frames.

FIG. 6 is a block diagram illustrating another embodiment of an encryption method of the present invention.

FIG. 7 is a block diagram illustrating another embodiment of a decryption method of the present invention.

FIG. 8 is a flow chart illustrating one embodiment of a data encryption method of the present invention.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DESCRIPTION OF THE PRESENT INVENTION

The present invention may be described herein in terms of algorithms and operations on data bits within a computer. It has proven convenient, primarily for reasons of common usage among those skilled in the art, to describe the invention in terms of algorithms and operations on data bits. It is to be understood, however, that these and similar terms are to be associated with appropriate physical elements, and are merely convenient labels applied to these physical elements. Unless otherwise stated herein, or apparent from the description, terms such as “providing”, “assigning”, “using”, “converting”, “transmitting”, “calculating”, “determining”, “processing”, “selecting”, “sending”, “receiving” or “computing”, or similar terms, refer the actions of a computing device that may perform these actions automatically, i.e., without human intervention, after being programmed to do so.

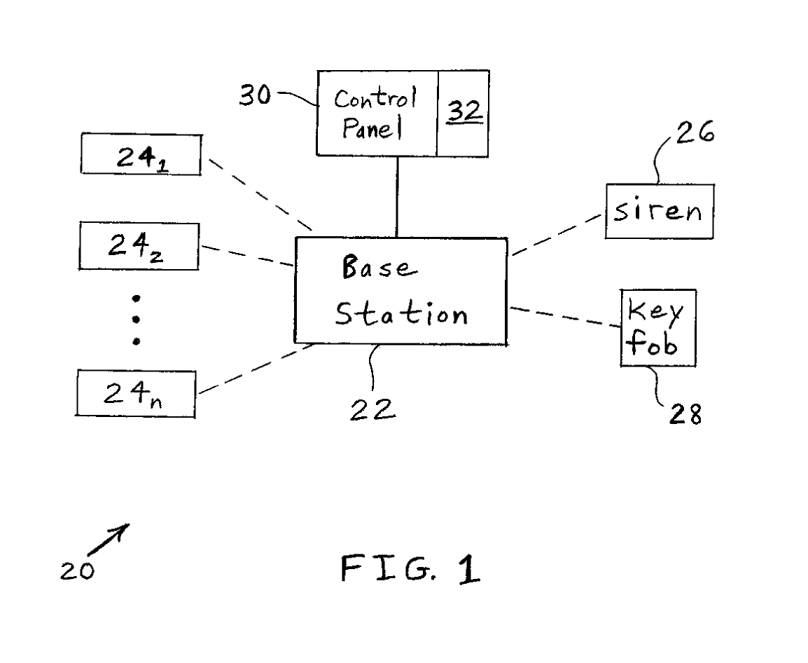

Referring now to the drawings and particularly to FIG. 1, there is shown one embodiment of a wireless network 20 suitable for use in conjunction with the encryption method of the present invention. Network 20 includes a base station, i.e., hub 22, a plurality of sensors 24₁, 24₂, . . . , 24ₙ, a siren 26, a key fob 28 and a control panel 30 that may include a keypad 32. Control panel 30 may be hard wired to hub 22, while sensors 24₁₋ₙ, siren 26 and key fob 28 are in wireless communication with hub 22, as indicated by the dashed lines in FIG. 1.

Base station 22 and control panel 30 may be powered by household alternating current, and sensors 24₁, 24₂, . . . , 24ₙ, siren 26 and key fob 28 may be battery powered. For sensors 24₁, 24₂, . . . , 24ₙ, siren 26 and key fob 28, base station 22 is the gateway to control panel 30, which the user can use to interact with the system. In one embodiment, network 20 is in the form of a wireless Local Security Network (wLSN) system which is a wireless intrusion and alarm system.

The actions of the protocol of the present invention can be divided into encryption steps taken by a sender node, i.e., a node that has a message to send, and decryption steps taken by a receiver node, i.e., a node whose task is to collect these sent messages. For example, a sensor 24 may be a sender node, and hub 22 may be a receiver node. However, it is to be understood that it is possible within the scope of the invention for any of the nodes to be a sender node, a receiver node, or both a sender node and a receiver node, depending upon the particular application. The time may be slotted, and each time slot may be used to exchange one data packet and its acknowledgment between a sender-receiver pair of nodes. All the nodes in the network may be synchronized with each other. For example, a synchronization protocol may be responsible for maintaining a network-wide clock in the system. A simple yet efficient method of keeping the network synchronized may be to periodically broadcast time beacon messages to all nodes from a central node, such as base station 22.

As discussed above, it may be assumed that the nodes of wireless network 20 are synchronized in the time domain. With time synchronization, the nodes may communicate with each other in a frame based manner. Communication may be scheduled frame by frame, and each node may maintain a frame counter. Each frame may be sliced or separated into multiple time slots. A node may be able to transmit only during its assigned time slots. The transmitted data from a node may have one or multiple recipient nodes. Similarly, a node may receive data from other nodes only during predefined time slots. More generally, communication related operations may need to be performed during a node's pre-assigned time slots.

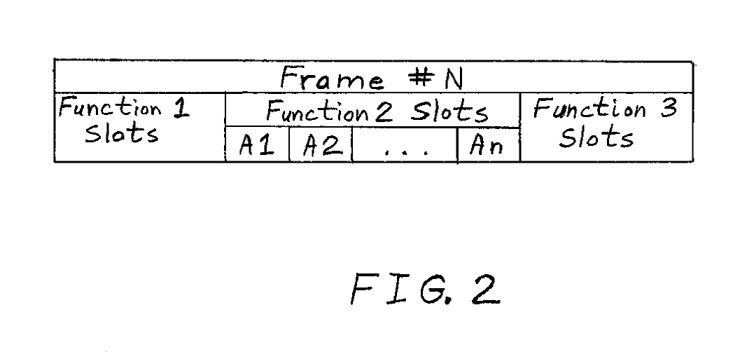

One specific embodiment of a format of a frame in the time domain is illustrated in FIG. 2. Function1 Slots are used for header information, Function2 Slots are used for payload information, and Function3 Slots are used for acknowledgments. Each of nodes 1 through n is assigned a respective time slot among the Function2 Slots to transmit its payload information to the other nodes. Although the described scenario is one of targeted time slots, the present invention may also be applied to other scenarios. The invention can be implemented in other general systems as well.

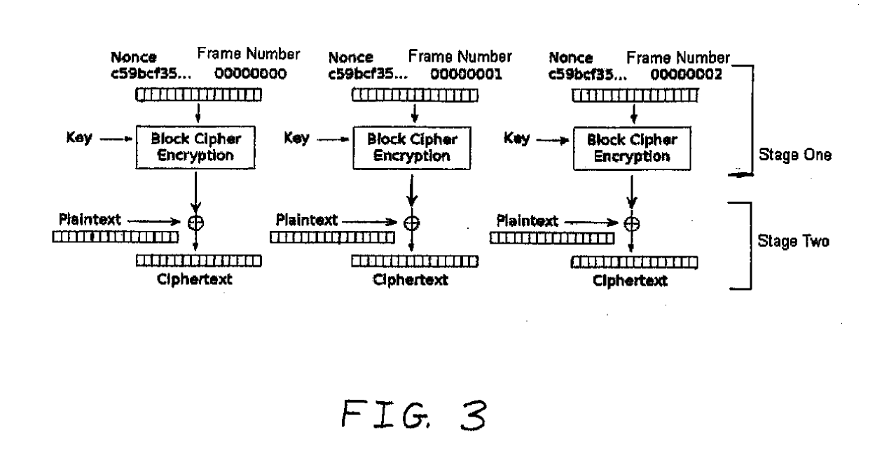

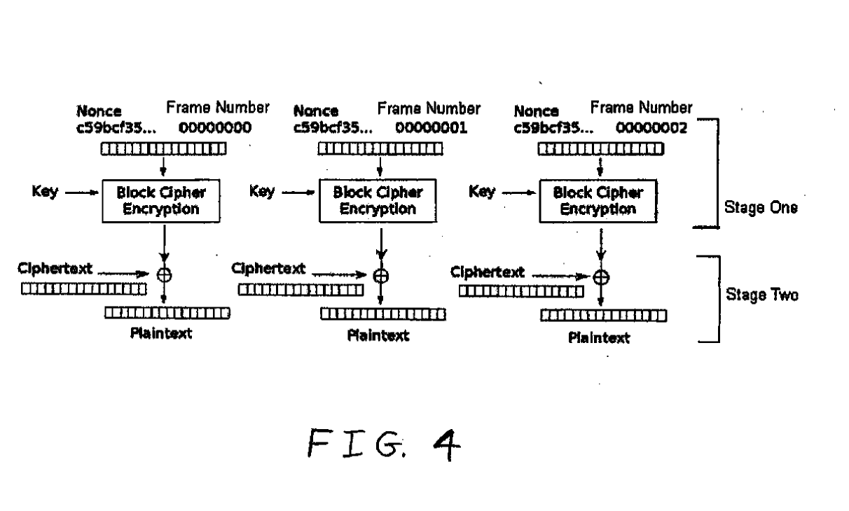

In the embodiment of the encryption/decryption method of the present invention illustrated in FIGS. 3 and 4, block ciphers are operated under the counter (CTR) mode. The encryption method, resulting in ciphertext, is illustrated in FIG. 3; and the decryption method, resulting in restoration of the plaintext, is illustrated in FIG. 4. For each frame of data (frames 0, 1 and 2 being illustrated in FIGS. 3 and 4), the sender node may perform preliminary calculation-intensive steps that are independent of the plaintext that is to be encrypted. More particularly, the sender node may perform the calculation-intensive step of Block Cipher Encryption using only the available inputs of the binary Nonce (randomly generated number) and the Security Key. The binary output of the Block Cipher Encryption may be stored in memory where this output is matched with an associated Frame Number. Because the Frame Numbers are predictable and known well in advance by system nodes, outputs of many Block Cipher Encryptions may be stored in memory in association with respective Frame Numbers before the Block Cipher Encryptions are put to use in encrypting the plaintext. For example, about one hundred Block Cipher Encryption outputs may be pre-calculated and stored in memory in association with respective Frame Numbers. The number of Block Cipher Encryption outputs that may be pre-calculated and stored in memory in this way may be limited by only the available memory and processing capacity of the system. Advantageously, the Block Cipher Encryption calculations may be performed any time the processor has available processing capacity, and thus may be performed well ahead of the time that the calculations need to be applied to encrypt the plaintext.

When the plaintext that is to be encrypted becomes available, the binary output of the Block Cipher Encryption is exclusive ORed (i.e., XORed) with the binary plaintext to produce ciphertext. The sender node then may send the encrypted ciphertext to the receiver node.

The receiver node, similarly to the sender node, may perform preliminary calculation-intensive steps that are independent of the ciphertext that is to be decrypted for each frame of data. More particularly, the receiver node may perform the calculation-intensive step of Block Cipher Encryption using only the available inputs of the binary Nonce and the Security Key. The Block Cipher Encryption is used for decrypting as well as for encrypting, and is mathematically equivalent in the two cases. Thus, in order to simplify the terminology, it is referred to as “encryption” even when used for decryption. The Nonces and the Frame Number(s) with which each Nonce is used may be transmitted from the sender node to the receiver node well ahead in time of the transmissions of the ciphertext from the sender node to the receiver node. The Security Key may be fixed or may periodically change, perhaps according to a predetermined pattern. The binary output of the receiver node's Block Cipher Encryption may be stored in memory where this output is matched with an associated Frame Number. Because the Frame Numbers are predictable and known well in advance by system nodes, outputs of many Block Cipher Encryptions may be stored in memory in association with respective Frame Numbers before the Block Cipher Encryptions are put to use in decrypting the ciphertext. For example, about one hundred Block Cipher Encryption outputs may be pre-calculated and stored in memory in association with respective Frame Numbers. The number of Block Cipher Encryption outputs that may be pre-calculated and stored in memory in this way may be limited by only the available memory and processing capacity of the system. Advantageously, the Block Cipher Encryption calculations may be performed any time the receiver node's processor has available processing capacity and has received the necessary Nonces from the sender node. Thus, the Block Cipher Encryption calculations may be performed well ahead of the time that the calculations need to be applied to decrypt the ciphertext.

When the ciphertext that is to be decrypted becomes available, the binary output of the Block Cipher Encryption is exclusive ORed (i.e., XORed) with the binary ciphertext to produce the restored plaintext. The receiver node then may process or make use of the plaintext in the same way that it would have had no encryption/decryption taken place.

In order to maintain network-wide synchronization, the frame index number may be fed into the encryption and decryption algorithm. The above-described encryption and decryption operations include a two-stage approach which distributes the computation load over the whole time frame. The whole encryption/decryption procedure is divided into two stages: Stage One pre-calculates necessary intermediate results for Stage Two operations, and involves the most computing-intensive operations. Stage Two conducts the real encryption/decryption operations with only bitwise XOR operations involved. More particularly, the first stages of both the encryption and the decryption include the Block Cipher Encryption. The second stages of the encryption and the decryption include XORing the plaintext with the Block Cipher Encryption output to produce ciphertext in the case of encryption, and XORing the ciphertext with the Block Cipher Encryption output to produce plaintext in the case of decryption.

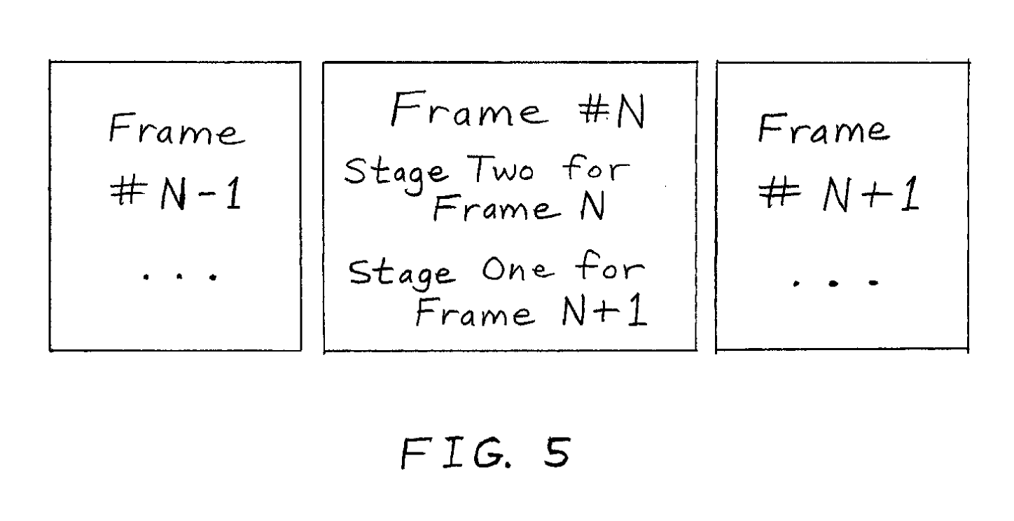

As described above, real-time response to encryption/decryption requests can be delivered given the availability of pre-calculated Stage One results for the current frame. Because the frame index number is predictable, a frame's Stage One Block Cipher Encryption calculations can be executed during the CPU's spare time of its preceding frame, as illustrated in FIG. 5. More specifically, FIG. 5 illustrates that the intensive Stage One calculations for the subsequent Frame N+1 may be conducted concurrently or simultaneously with the less intensive Stage Two operations for the current Frame N. In the embodiment illustrated in FIG. 5, the Stage One calculations are performed only one frame ahead of the associated Stage Two calculations. However, in other embodiments, the Stage One calculations are performed up to one hundred or more frames ahead of the associated Stage Two calculations. The intensive Stage One calculations may be performed at any time that the CPU of the sender node or the receiver node has spare or idle time.

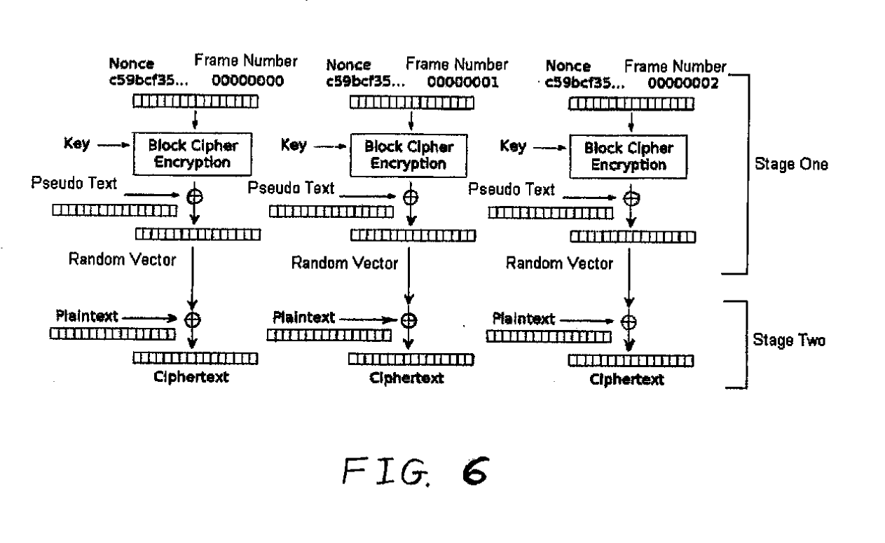

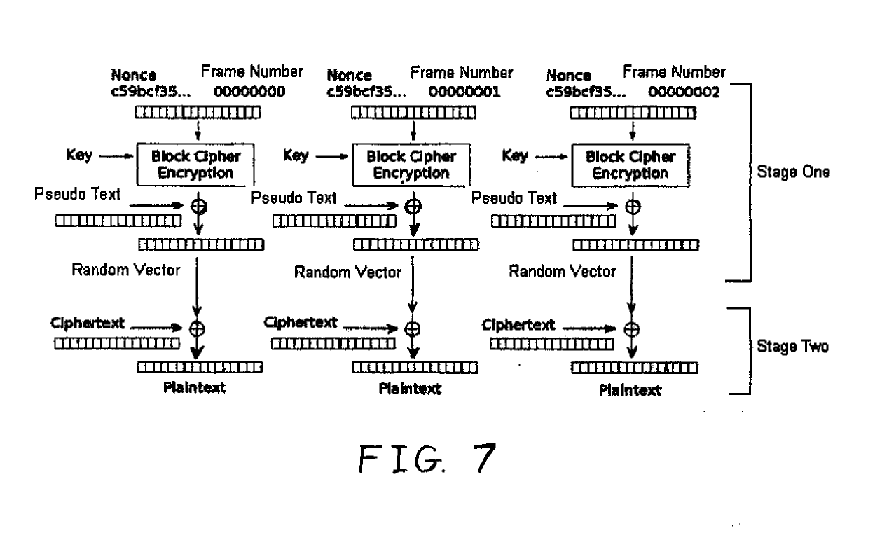

In another embodiment, illustrated in FIGS. 6 and 7, another XORing step is added to both the Counter (CTR) mode encryption (FIG. 6) and the Counter mode decryption (FIG. 7). More particularly, in each case, an arbitrary binary string of Pseudo Text is XORed with the binary output of Block Cipher Encryption to produce a Random Vector. The Random Vector may change with each new Frame Number. It is then the Random Vector that is XORed with plaintext to produce ciphertext in the case of encryption, and with ciphertext to produce plaintext in the case of decryption.

The introduction of Pseudo Text may provide the advantage of enhancing system security. The Pseudo Text adds another layer of protection in addition to the Security Key, Frame Index and Nonce.

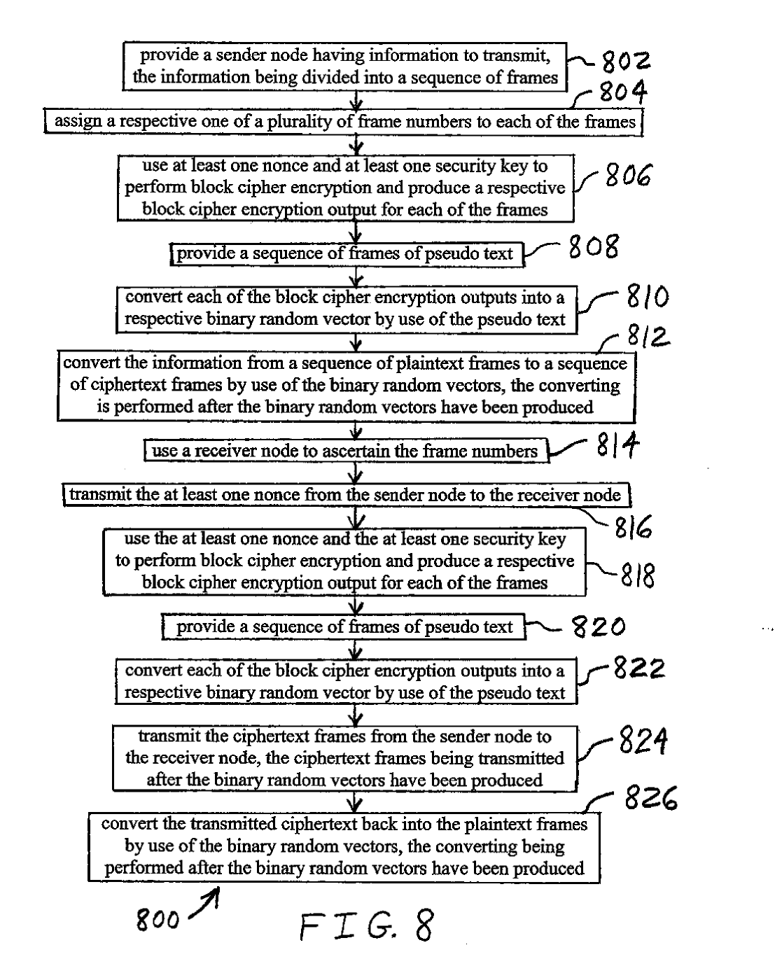

One embodiment of a data encryption method 800 of the present invention is illustrated in FIG. 8. In a first step 802, a sender node is provided having information to transmit. The information is divided into a sequence of frames. For example, as shown in FIG. 1, a sender node 24 may have information to wirelessly transmit to a receiver node in the form of base station 22. The information may be in the form of plaintext (FIG. 6) that is divided into a sequence of frames numbered 00000000, 00000001, 00000002, etc.

In a next step 804, a respective one of a plurality of frame numbers is assigned to each of the frames. As discussed above, each of the frames may be assigned a frame number such as 00000000, 00000001, 00000002, etc.

Next, in step 806, at least one nonce and at least one security key are used to perform block cipher encryption and produce a respective block cipher encryption output for each of the frames. For example, as illustrated in FIG. 6, a nonce (shown as c59bcf35 . . . ) and a security key (shown as “Key”) are inputs to the Block Cipher Encryption. Each of the three Block Cipher Encryption blocks shown in FIG. 6 produces a separate output corresponding to a respective one of the three frames shown (numbered 00000000, 00000001, and 00000002).

In a next step 808, a sequence of frames of pseudo text is provided. That is, as shown in FIG. 6, frames of “Pseudo Text” are provided. “Pseudo Text” is a common shared string of text between senders and receivers. It can be as simple as “000 . . . 00”, or as complicated as a function of frame index and other arguments. The Pseudo Text is not necessarily a long string. A short text of several or tens of bytes may also serve the purpose.

Step 810 includes converting each of the block cipher encryption outputs into a respective binary random vector by use of the pseudo text. For example, as shown in FIG. 6, the outputs of the Block Cipher Encryptions are converted into respective Random Vectors by XORing the Block Cipher Encryption outputs with the Pseudo Text.

Next, in step 812, the information is converted from a sequence of plaintext frames to a sequence of ciphertext frames by use of the binary random vectors. The converting is performed after the binary random vectors have been produced. For example, as shown in FIG. 6, the Plaintext is converted to the Ciphertext by XORing the Plaintext with the Random Vector. Each of the three Random Vectors shown in FIG. 6 (or any other number of Random Vectors, limited by only available memory and processing power) may be produced before Plaintext is XORed with any of the Random Vectors, and perhaps before any of the three frames of Plaintext have even been received.

In a next step 814, a receiver node is used to ascertain the frame numbers. For example, a receiver node in the form of base station 22 may maintain a frame counter that enables the receiver node to independently ascertain frame numbers associated with respective frames of Plaintext that the receiver node may receive in the future. More generally, in order to maintain network-wide frame counter synchronization, the frame index number may be fed into the encryption and decryption algorithm.

In step 816, the at least one nonce is transmitted from the sender node to the receiver node. That is, after randomly generating the nonce, a sender node 24 may transmit the nonce to a receiver node 22.

In step 818, the at least one nonce and the at least one security key are used to perform block cipher encryption and produce a respective block cipher encryption output for each of the frames. For example, as illustrated in FIG. 7, the receiver node performing decryption may use a nonce (shown as c59bcf35 . . . ) and a security key (shown as “Key”) as inputs to the Block Cipher Encryption. Each of the three Block Cipher Encryption blocks shown in FIG. 7 produces a separate output corresponding to a respective one of the three frames shown (numbered 00000000, 00000001, and 00000002).

Next, in step 820, a sequence of frames of pseudo text is provided. That is, as shown in FIG. 7, frames of “Pseudo Text” are provided within a receiver node.

In a next step 822, each of the block cipher encryption outputs is converted into a respective binary random vector by use of the pseudo text. For example, as shown in FIG. 7, the outputs of the Block Cipher Encryptions are converted into respective Random Vectors by XORing the Block Cipher Encryption outputs with the Pseudo Text within a receiver node.

Step 824 includes transmitting the ciphertext frames from the sender node to the receiver node. The ciphertext frames are transmitted after the binary random vectors have been produced. For example, the Ciphertext produced in FIG. 6 by a sender node 24 may be transmitted from the sender node to a receiver node 22. Each of the three Random Vectors shown in FIG. 7 (or any other number of Random Vectors, limited by only available memory and processing power) may be produced within the receiver node before the Ciphertext is transmitted by the sender node or is received by the receiver node.

In a final step 826, the transmitted ciphertext is converted back into the plaintext frames by use of the binary random vectors. The converting is performed after the binary random vectors have been produced. For example, as shown in FIG. 7, the Ciphertext is converted to the Plaintext by XORing the Ciphertext with the Random Vector. Each of the three Random Vectors shown in FIG. 7 (or any other number of Random Vectors, limited by only available memory and processing power) may be produced before Ciphertext is XORed with any of the Random Vectors, and perhaps before any of the three frames of Ciphertext have even been received by the receiver node from the sender node.

As described above, the Block Cipher Encryption calculations may be performed independently of the Frame Numbers with which the calculations are associated. However, in another embodiment, the Frame Numbers are also inputs of the Block Cipher Encryption calculations, and thus the Block Cipher Encryption calculations are not performed independently of the Frame Numbers.

The method of the present invention may be used for all embedded systems where information is sent from one node to other nodes in a time division multiple access (TDMA) fashion. Such embedded systems may be used in building security, automotive applications, and industrial control systems, for example.

The present invention provides a general purpose solution for implementing computationally intensive encryption and decryption algorithms in networked embedded systems with relatively low computational power. Such applications include wireless sensor networks in building security, automotive networks and industrial control networks, as well as their counterparts in wired networks. The encryption/decryption algorithms many be any block cipher working in the counter (CTR) mode, for example.

While this invention has been described as having an exemplary design, the present invention may be further modified within the spirit and scope of this disclosure. This application is therefore intended to cover any variations, uses, or adaptations of the invention using its general principles.

What is claimed is:

1. A data encryption method comprising the steps of:
providing a sender node having information to transmit, the information being divided into a sequence of frames;
assigning a respective one of a plurality of frame numbers to each of the frames;
using at least one nonce and at least one security key to perform block cipher encryption and produce within the sender node a respective block cipher encryption output for each of the frames;
converting the information from a sequence of plaintext frames to a sequence of ciphertext frames by use of the block cipher encryption outputs produced within the sender node, the converting being performed within the sender node and after the block cipher encryption outputs have been produced within the sender node;
using a receiver node to ascertain the frame numbers;
transmitting the at least one nonce from the sender node to the receiver node;
using the at least one nonce and the at least one security key to perform block cipher encryption and produce within the receiver node a respective block cipher encryption output for each of the frames;
transmitting the ciphertext frames from the sender node to the receiver node, the ciphertext frames being transmitted after the block cipher encryption outputs have been produced within the receiver node; and
converting the transmitted ciphertext back into the plaintext frames by use of the block cipher encryption outputs produced within the receiver node, the converting being performed within the receiver node and after the block cipher encryption outputs have been produced within the receiver node.

2. The method of claim 1 wherein the step of converting the information includes:
providing a sequence of frames of pseudo text;
converting each of the block cipher encryption outputs produced within the sender node into a respective binary random vector produced within the sender by use of the pseudo text; and
converting the information from the sequence of plaintext frames to the sequence of ciphertext frames by use of the binary random vectors produced within the sender.

3. The method of claim 2 wherein the step of converting the transmitted ciphertext includes:
providing a sequence of frames of pseudo text;
converting each of the block cipher encryption outputs produced within the receiver node into a respective binary random vector produced within the receiver by use of the pseudo text; and
converting the transmitted ciphertext back into the plaintext frames by use of the binary random vectors produced within the receiver.

4. The method of claim 1 wherein at least one of the sender node and the receiver node are part of an embedded system.

5. The method of claim 1 wherein the sender node and the receiver node are synchronized in the time domain.

6. The method of claim 1 wherein each of the sender node and the receiver node maintains a frame counter.

7. The method of claim 1 wherein the block cipher encryption operates in a counter mode.

8. The method of claim 1 wherein the nonce is randomly generated.

9. The method of claim 1 wherein each of the converting steps includes bitwise exclusive OR logic operations.

10. The method of claim 1 wherein each block cipher encryption is performed during a frame immediately preceding a frame in which a corresponding said converting step is performed.

11. A data encryption method comprising the steps of:
providing information that is divided into a sequence of frames;
assigning a respective one of a plurality of frame numbers to each of the frames;
using at least one nonce and at least one security key to perform block cipher encryption and produce a respective block cipher encryption output for each of the frames; and
converting the information from one of a sequence of plaintext frames and a sequence of ciphertext frames to an other of the sequence of plaintext frames and the sequence of ciphertext frames, the converting being performed by use of the block cipher encryption outputs, the converting being initiated after a group of the block cipher encryption outputs have been produced, the converting being initiated before any of the group of the block cipher encryption outputs have been used in a converting step.

12. The method of claim 11 wherein the block cipher encryption operates in a counter mode.

13. The method of claim 11 wherein the nonce is randomly generated.

14. The method of claim 11 wherein the converting step includes bitwise exclusive OR logic operations.

15. A data encryption method comprising the steps of:
providing information that is divided into a sequence of frames;
assigning a respective one of a plurality of frame numbers to each of the frames;
using at least one nonce and at least one security key to perform block cipher encryption and produce a respective block cipher encryption output for each of the frames;
providing a sequence of frames of pseudo text;
converting each of the block cipher encryption outputs into a respective binary random vector by use of the pseudo text; and
converting the information from one of a sequence of plaintext frames and a sequence of ciphertext frames to an other of the sequence of plaintext frames and the sequence of ciphertext frames, the converting of the information being performed by use of the binary random vectors, the converting of the information being initiated after the converting of the block cipher encryption outputs into the binary random vectors, the converting of the information being initiated before any of the binary random vectors have been used in a converting step.

16. The method of claim 15 wherein the block cipher encryption operates in a counter mode.

17. The method of claim 15 wherein the nonce is randomly generated.

18. The method of claim 15 wherein the converting step includes bitwise exclusive OR logic operations.

19. The method of claim 15 wherein the information is converted from a sequence of plaintext frames to a sequence of ciphertext frames, the steps of the method being performed within a sender node, the method comprising the further step of transmitting the ciphertext frames from the sender node to a receiver node.

20. The method of claim 19 comprising the further step of converting the transmitted ciphertext frames back into the plaintext frames by use of binary random vectors produced within the receiver node, the converting of the transmitted ciphertext frames being initiated within the receiver node, after a group of the binary random vectors have been produced within the receiver node, and before any of the group of the binary random vectors have been used in a converting step.
